(19) United States
(12) Patent Application Publication
(10) Pub. No.: US 2017/0220950 A1
(43) Pub. Date: Aug. 3, 2017

(54) NUMERICAL EXPRESSION ANALYSIS

(71) Applicant: International Business Machines Corporation, Armonk, NY (US)

(72) Inventors: Donna K. Byron, Petersham, MA (US); Edward E. Seabolt, Georgetown, TX (US); Timothy P. Winkler, Clinton, MA (US)

(21) Appl. No.: 15/010,439

(22) Filed: Jan. 29, 2016

(51) Int. Cl. G06N 99/00; G06F 17/27

(52) U.S. Cl. CPC G06N 99/005; G06F 17/2705

(57) ABSTRACT

A method, computer program product and computer system are provided. A processor identifies a plurality of numeric expressions in a text corpus associated with a type of item. A processor generates a plurality of feature vectors corresponding to the identified plurality of numeric expressions. A processor identifies one or more common features of the plurality of feature vectors. A processor generates one or more rules for representing numeric quantities of the type of item based, at least in part, on the one or more common features of the plurality of feature vectors.

### BACKGROUND OF THE INVENTION

The present invention relates generally to the field of semantic analysis, and more particularly to determining frequent forms of numeric expression for items in a corpus of text.

Semantic analysis is a method building data structures to represent concepts appearing in a variety of documents. Patterns among the documents may be used to infer certain concepts. In machine learning, large collections of text (e.g., a corpus of text documents) are ingested to generate data structures. Based on the occurrences of certain terms, or groups of terms, a machine learning program determines common occurrences or concepts used among the corpus of text.

### SUMMARY

Embodiments of the present invention provide a method, system, and program product to generate rules for representations of numeric values for items. A processor identifies a plurality of numeric expressions in a text corpus associated with a type of item. A processor generates a plurality of feature vectors corresponding to the identified plurality of numeric expressions. A processor identifies one or more common features of the plurality of feature vectors. A processor generates one or more rules for representing numeric quantities of the type of item based, at least in part, on the one or more common features of the plurality of feature vectors.

### BRIEF DESCRIPTION OF THE SEVERAL VIEWS OF THE DRAWINGS

FIG. 1 is a functional block diagram illustrating a networked environment, in accordance with an exemplary embodiment of the present invention.

FIG. 2 illustrates operational processes of an expression program, on a computing device within the environment of FIG. 1, in accordance with an embodiment of the present invention.

FIG. 3 illustrates an example flow diagram of an expression program, in accordance with an embodiment of the present invention.

FIG. 4 depicts a block diagram of components of the computing device executing an expression program, in accordance with an embodiment of the present invention.

### DETAILED DESCRIPTION

In artificial intelligence systems, providing output that appears natural or fluent to a user is of great importance. This is particularly true when generating output that contains numeric expressions. With the vast precision of a computing platform, providing a quantity with too many digits may break the purpose of the artificial intelligence system. Furthermore, in specific domains, the formatting and representation of the quantities may vary immensely from other domains. Prior solutions required specific design to handle each domain and scenario. Embodiments of the present invention recognize that by ingesting text corpus from target domains, rules for expression quantities in said domains can be inferred. Such rules may be used to generate expressions of numeric quantities such that they appear in a natural, and expected, manner for the domain to a user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

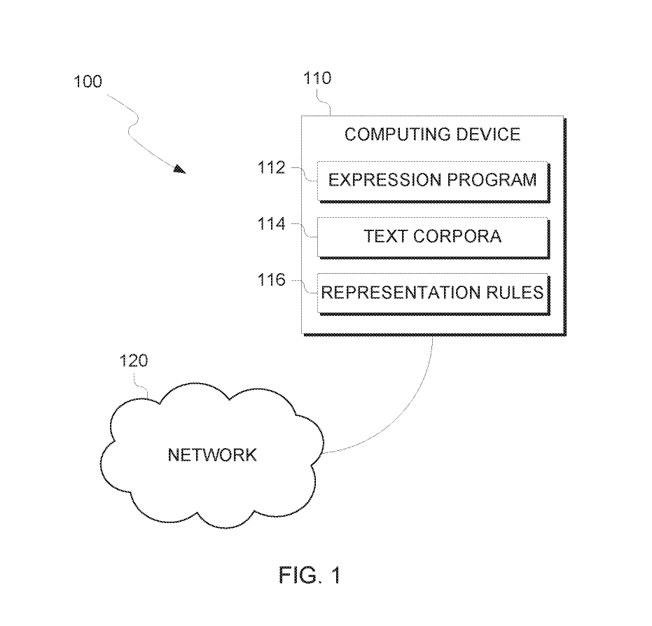

The present invention will now be described in detail with reference to the Figures. FIG. 1 is a functional block diagram illustrating networked environment, generally designated 100, in accordance with one embodiment of the present invention. Networked environment 100 includes computing device 110 connected to network 120. Computing device 110 includes expression program 112, text corpora 114 and representation rules 116.

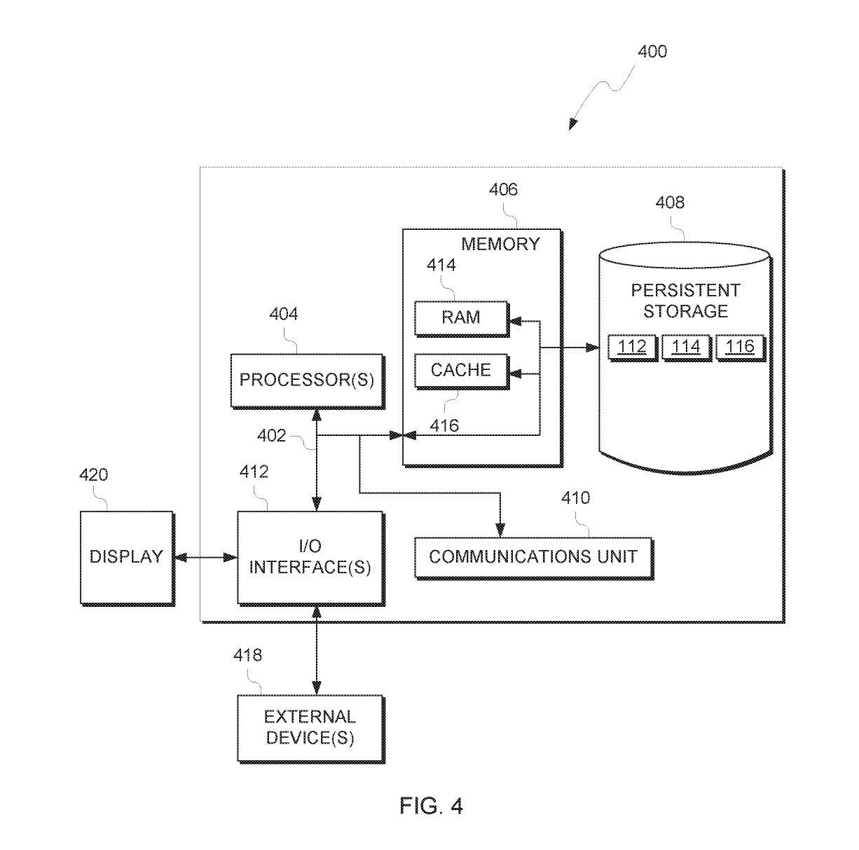

In various embodiments of the present invention, computing device 110 is a device that can be a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to text corpora 114 and representation rules 116 and is capable of executing expression program 112. Computing device 110 may include internal and external hardware components, as depicted and described in further detail with respect to FIG. 4.

In this exemplary embodiment, expression program 112, text corpora 114 and representation rules 116 are stored on computing device 110. However, in other embodiments, expression program 112, text corpora 114 and representation rules 116 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 110 and other devices (not shown), in accordance with a desired embodiment of the present invention.

In various embodiments, expression program 112 digests at least one text corpus from text corpora 114. Text corpora 114 includes various bodies of text categorized into various domains. For example, text corpora 114 includes a collection of texts from cooking domains and another collection of texts from a driving or navigation domain. Based on the numeric expressions found in a given category, expression program 112 determines representation rules 116 for items found in a text corpus of text corpora 114. In some embodiments, expression program 112 determines common units used to measure items identified in a text corpus (e.g., vinegar in recipes found in a text corpus is typically represented by tablespoons). In some embodiments, expression program 112 determines common formatting of numerical quantities associated with units identified in a text corpus (e.g., distance is represented in miles and typically presented in decimal format with a tenth of a mile for precision).

In some embodiments, a text corpus in text corpora 114 is further categorized in one or more subcategories. In one scenario, a text corpus is further categorized based on the content of the documents. For example, a text corpus of recipes is categorized into dessert recipes, appetizer recipes, and the like. In another scenario, a text corpus is further categorized based on the metadata regarding the documents in the text corpus. For example, document in a text corpus are further categorized based on a region the respective documents originated from.

In some embodiments and scenarios, expression program 112 generates representation rules 116 based on the categorization of a text corpus. For example, and as discussed herein, expression program 112 determines common or frequent representations of numerical expressions in a text corpus. By categorizing a corpus (e.g., recipes from different countries or culinary disciplines), expression program 112 determines nuances and differences in representing numerical expressions between the categories. As such, expression program 112 automatically determines common or frequent numerical representations within each text corpus of text corpora 114 without the need for a programmer or other user to provide the various rules for each domain or category of text corpora 114 or any other categorization included therein. One of ordinary skill in the art will appreciate that any categorization of text corpora 114 may be used without deviating from the invention. By categorizing text corpora 114 into various domains or any other area of interest, common numerical expressions can be derived for the target area without need of a programmer or other designer's alteration to expression program 112 or representation rules 116.

In some embodiments, expression program 112 receives or retrieves a document to include in text corpora 114. In one scenario, expression program 112 receives an indication of domain or categorization of the incoming document. In another scenario, expression program 112 analyzes the incoming document to determine the content of the document, and thereby determining a categorization based on the determined content of the document. In some embodiments, expression program 112 receives or retrieves a video or audio file for including in text corpora 114. Expression program 112 transcribes the audio file or portion of audio of the video file. Expression program 112 stores the transcribed text in text corpora 114.

In some embodiments, expression program 112 identifies numerical expressions in one or more documents of a text corpus in text corpora 114. In some scenarios and embodiments, expression program 112 identifies numerical expression based on the presence of a number in the body of a document in a text corpus. Upon identifying a numerical expression, expression program 112 extracts the numerical expression in addition to features related to the identified expression. Such features includes, but is not limited to, the numeric value, a normalized numeric value (e.g., all measurements are converted to a particular unit such as weight measurements converted to grams), an expression type (i.e., fractional, decimal, scientific, and the like), numerical precision (i.e., denominator value in a fraction or the number of decimal places), unit of the expression (e.g., grams, gallons, miles, kilometers, etc.), item measured by the expression (e.g., amount of flour, walking distance, blood pressure, etc.), and other contextual information to identify the purpose of the numerical expression (e.g., action verbs, headings and other textual elements).

In some embodiments, expression program 112 identifies numerical expressions based on an item name or descriptor located in one or more documents of a text corpus in text corpora 114. In some embodiments or scenarios, expression program 112 generates expression rules 116 for particular items by identifying numerical expressions associated with the name item in additional to other features (e.g., expression type, precision, unit, and other contextual information) related to each occurrence of the item in the text corpus. For example, a user or other program (not shown) may request from expression program 112 a representation rule for a particular type of item, and in some scenarios a particular domain, such as a representation rule for numerical expressions of sugar in a confectionary domain. In this example, expression program 112 selects a text corpus from the confectionary domain from text corpora 114. Expression program 112 identifies corresponding numerical expression corresponding to measurement of sugar. As discussed herein, expression program 112 determines common or frequent numerical expressions of sugar in the text corpus, thereby providing representation rules 116 associated with sugar to the user or requesting program.

In various embodiments, expression program 112 generates a table representing the various features represented by each numeric expression of a particular item. The table comprise a feature vector for each instance of a numeric expression in the text corpus being evaluated. For example, in a text corpus of craft construction instructions, all features of numeric expressions for measurements of yarn (i.e., the item) are collected as feature vectors in a table for each instance of a measurement. In this example, each feature vector includes an numeric expression type (e.g., “decimal” for number with decimal places such as 4.5 yards and “fractional” for numbers with fractional portions such as 4 and ½ yards), precision (e.g., for decimal expressions the number of decimal places such as “1” for 4.5 yards and the denominator for numbers with fractions such as “2” for 4 and ½ yards), unit (e.g., the unit of measurement for the yarn such as yards of feet). In various embodiments, each feature vector includes a normalized conversion of the number in the numeric expression. Expression program 112 includes conversion for each unit type. For comparison purposes, expression program 112 converts each number to a normalized equivalent. For example, referring back to a text corpus of craft construction instructions with a table being generated for the item yarn, all numeric expression are converted to inches or feet so that the amount being measured can later be equally compared.

In various embodiments, expression program 112 create a feature space with the generated table of each feature vector for instance of numeric expressions for an item. Each feature of the feature vectors corresponds to a dimension in the feature space (e.g., expression type corresponds to a dimension and unit type corresponds to another dimension). As such, common or frequently used features of numeric expression for the item will group into sections of the feature space. In some embodiments, expression program 112 removes particular feature vectors from the table based on one or more features of the vector being outliers from other features in the feature space. For example, a large percentage of vectors have “kg” as the unit identifier for measurement. If a feature vector representing an instance of a numeric expression uses a “lbs.” unit, then expression program 112 removes the feature vector for the numeric expression from the table and by consequence the feature space.

In various embodiments, expression program 112 determines groups of features in the feature space. Such groupings represent common or frequently used features of numeric expressions among feature vectors for a particular item. For example, expression program 112 determines common groupings based on cluster analysis of the feature space. Feature vectors with similar features create closely grouped “clusters” of points in the feature space. Expression program 112 determines groupings of features based on the distribution of the feature sectors in the feature space. If a larger portion of feature vectors have a decimal expression type, then expression program 112 determines that decimal representation is common or frequently used for the item. Based on the clustering and distribution of features in the feature space, expression program 112 generates representation rules 116 that indicate common or frequently used features in representing numeric expressions within the selected text corpus.

By using cluster analysis, expression program 112 determines common or frequently used numeric expressions used in a text corpus for a particular item (e.g., vinegar is commonly measured in tablespoons). Based on the scope of the text corpus, the common or frequently used numeric expression features for an item can be selected for a variety of scenarios. For example, common features for measurements of vinegar in a barbeque domain can vary from measurements of vinegar in a salad dressing (e.g., a numeric expression for vinegar in a salad dressing recipe may use tablespoons where a barbeque recipe may refer to vinegar using teaspoons). By selecting the domain of references within the various bodies of documents in text corpora, expression program 112 generates a variety of representation rules 116 for the respective domains.

In various embodiments, expression program 112 determines common or frequently used features across multiple features in the feature space. In some scenarios, based on the normalized values in the numeric expressions, the common or frequently used features in a feature space may vary. For example, for smaller normalized values of a measurement in a confectionary recipe a “pinch” or teaspoon may be used, while larger normalized values for the same item type use grams or cups. Based on the clustering analysis, expression program 112 determines the normalized values for the item that separate unit clusters are used within the text corpus.

When a statistically significant portion of a cluster (e.g., 67% or 95% of the cluster falls within a normalized value range) contains a certain feature when compared along the normalized value feature dimension, expression program 112 determines a common or frequently used feature for the range. Therefore, in some embodiments and scenarios, expression program 112 determines representation rules 116 for an item type that change based on the normalized numeric value of the item. For example, a representation rule 116 for an item may switch between decimal and fractional expression types based on the numerical value represented (e.g., smaller values may use a fractional expression while larger values use a decimal representation). As such, representation rules 116 may present different common features based on the value being represented including, but not limited, to the expression type, the precision of the expression and the unit used in the expression.

By selecting the domain and ingesting documents from said domain, expression program 112 provides representation rules 116 commonly used in the domain. Furthermore, by creating a feature space, as discussed herein, expression program 112 provides representation rules 116 that capture the variations used with the selected domain when representing numeric expressions of items. By selecting the text corpus based on a domain, expression program 112 determines varying ways of representing numbers. Be it measurements of the same item across different disciplines of fields of use, expression program 112 automatically determines the common and frequently used representation rules 116 of the domain. Such solutions presented herein provide the advantage of prior solutions, which would require manual analysis and programming. Furthermore, expression program 112 provides representations that can change over a variety of domains without any changes to expression program 112.

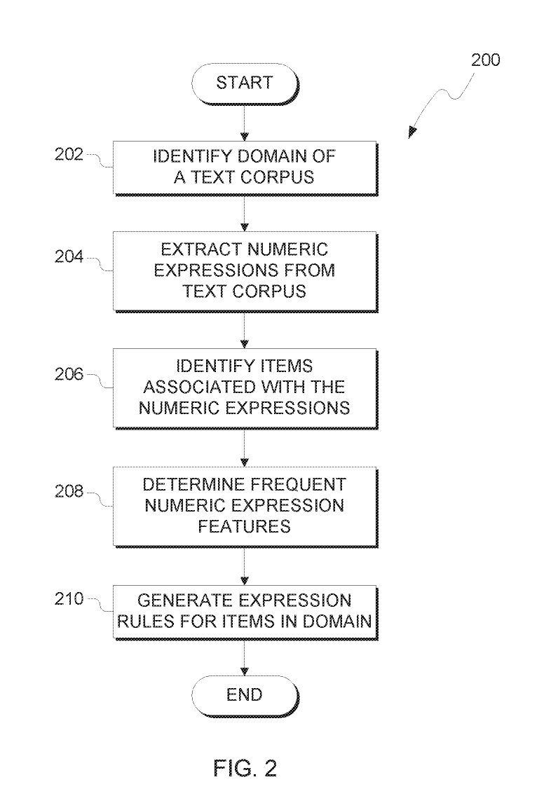

FIG. 2 illustrates operational processes, generally designated 200, of expression program 112. In process 202, expression program 112 identifies the domain of a text corpus from text corpora 114. In some embodiments or scenarios, the text corpus is categorized within text corpora 114 to indicate the domain. For example, the domain of the text corpus may be categorized as a group of cooking instructions, driving directions, medical instrumentation readings, or any domain with numerical expressions contained in a document of the text corpus. In some embodiments or scenarios, the domain of a text corpus or a document of text corpora 114 is not known. In such scenarios, expression program 112 performs natural language processing (NLP) to determine the domain of the text corpus or the document. In some embodiments or scenarios, a document in the text corpus includes multiple domains (e.g., a magazine has been included as a document, where one page has a recipe and another has instructions to construct a craft). In such scenarios, expression program 112 determines the domain for each portion of the document based on contextual information. Expression program performs NLP to the surrounding text, headings and other information to determine a domain for each portion.

In process 204, expression program 112 extracts numeric expressions from documents in the text corpus. Expression program 112 identifies numeric expression within document of the text corpus. Expression program 112 extracts various features of each numeric expression including, but not limited to, the numeric value, the expression type, the precision of the expression, the unit used in the expression and the item measured. In some scenarios, expression program 112 also extracts other contextual information. In one scenario, expression program 112 analyzes, via NLP, the contextual information to determine a domain for the numeric expression. For example, a document includes two distances in a direction. One is a walking distance and another is a driving distance. Based on the extracted contextual information, expression program 112 determines that both distances represent two different items (i.e., a walking distance measurement and a driving distance measurement).

In process 206, expression program 112 identifies the item associated for each extracted numeric expression. In some scenarios, expression program 112 extracts the item along with the numeric expression (e.g., 4 cups of flour). In other scenarios, expression program 112 analyzes contextual information to determine the item represented by the numeric expression, such as a heading or the sentence of text the numeric expression was extracted from. In various embodiments, expression program 112 groups numeric expressions for similar items. For example, expression program 112 collects all numeric expression relating to sugar in one group and all numeric expressions related to drywall into another group. In some embodiments or scenarios, expression program 112 may further categorize item groupings based on properties of the item. For example, milk is found to be used in various recipes. In some recipes a solid form of powdered milk is measured in a numeric expression and in other recipes a liquid form of milk is measured. In such scenarios, expression program 112 creates two subcategorized groupings for solid and liquid milk.

In process 208, expression program 112 determines frequent numeric expression features for each grouping of items. Expression program 112 generates a feature vector for each instance of a numeric expression within the item group. Expression program 112 combines the feature vectors to create a feature space representing the features used to represent items of the group with numerical expression. Such features include, but are not limited to numeric value, a normalized numeric value, numeric expression type (e.g., fractional, decimal, scientific), numeric precision (e.g., number of decimal places or denominator in fractional expressions), and unit used in the expression (e.g., kilometers, miles, gallons, or liters). The feature space creates a multidimensional space where each vector is mapped to. Frequently used or common features in the extracted numeric expression create groupings or clusters. Based on the selected clusters, expression program 112 determines representation rules 116 to convey the common or frequently used numeric expression features with the domain for the item grouping (process 210).

In some embodiments and scenarios, expression program 112 selects multiple clusters based upon patterns across multiple features. For example, a cluster of features indicate that a certain unit type is used in the text corpus for a range of numeric values and another unit type for a different range of numeric values (e.g., for small quantities of a liquid milliliters are used, and for larger quantities, gallons are used. By normalizing the numeric values as a dimension in the feature vector, expression program 112 determines when the change in numeric value indicates a change in features. Expression program 112 determines changes in expression type, precision and unit of the numeric expression based on the normalized numeric value. When clustering of features change in comparison to the numeric value, expression program 112 generates representation rules 116 that reflect the common or frequent features of measurements based on the value of the item (process 210).

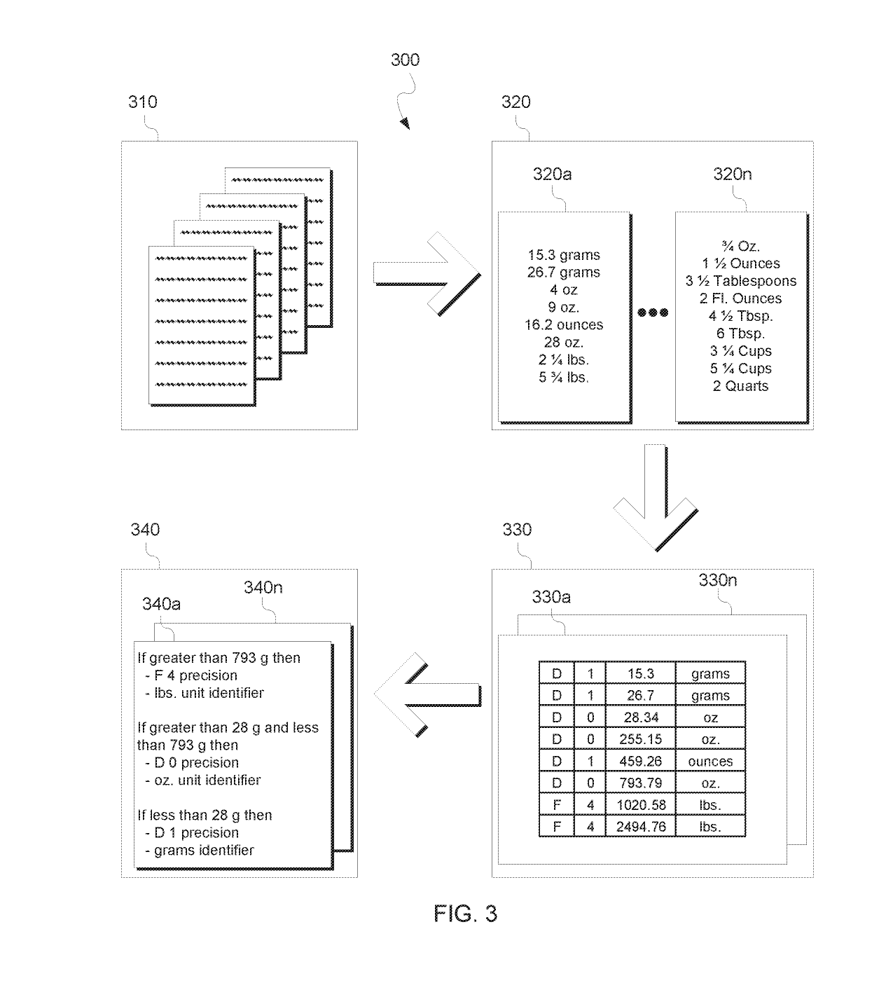

FIG. 3 illustrates an example flow diagram, generally designated 300, of expression program 112. Expression program 112 retrieves a text corpus 310 from text corpora 114. In some embodiments, expression program 112 receives text corpus 310 from another program or device. Text corpus 310 includes a body of documents. In some embodiments, text corpus 310 includes documents, or portion of documents, with text or transcriptions of audio or video including content from one or more domains. A domain is a subject matter area and may include any number of categories or subcategories encompassing the subject matter area. In this example, text corpus 310 includes a variety of recipes with ingredients. However, one of ordinary skill will appreciate that text corpus 310 may include any type of subject matter with numerical expressions without deviating from the invention.

Expression program 112 ingests text corpus 310 to identify and extract item groups 320. Each grouping of item groups 320 includes numerical expressions for a particular item. In this example, item group 320a is for a solid ingredient such as flour item group 320n is for a liquid ingredient such as vinegar. Item groups 320 include the numerical expression as identified from documents in text corpus 310 (e.g., 15.3 grams, 4½ Tbsp., and 2 Quarts) with numerical expressions regarding the respective item corresponding to the item groups 320. In some embodiments or scenarios, expression program 112 combines item groups 320 based on similarities in the item's name or properties. For example, variations and shorthand for an item may be combined into a single group of item groups 320.

As another example, if a desired representation rule of representation rules 116 for an item is not present and a text corpus is not present for the item, then expression program 112 compares the properties of the desired item to items of items groups 320 for similar properties. When matching items are identified, expression program 112 provides representation rules 116 corresponding to the similar item. For example, a user provides expression program 112 with a request for representation rules 116 for milk. In some embodiments, expression program 112 identifies a text corpus with milk items and generates representation rules for numeric expressions regarding milk. In other embodiments, expression program 112 provides representation rules 116 for items similar to the desired item (e.g., representation rules 116 for vinegar's item group 320n due to a similar liquid property).

Expression program 112 generates feature tables 330 for each of item groups 320. Feature tables 330 convert each feature of the numeric expressions from the corresponding item groups 320 to a feature vector. In this example, the feature vectors are represented by a row in the table. One of ordinary skill will appreciate that any configuration and representation of the feature vectors may be used without deviating from the invention. Feature table 330a illustrates a feature table corresponding to item group 320a. Similarly, feature table 330n illustrates a feature table corresponding to item group 320n. Feature table 330a includes four columns corresponding to four features of the numeric expressions in item group 320a. The first column represents the expression type feature, with D for decimal and F for fractional. The second column represents the precision feature of the numeric expressions. For decimal expressions, the column represents the number of decimal places. For fractional expressions, the column represents the denominator used (e.g., 2 for a ½ fraction expression). The third column represents the normalized value of the numeric expression. In this example, grams have been selected as the base unit. The fourth column represents the unit identifier as extracted from text corpus 310.

Based on the corresponding feature tables 330, expression program 112 generates rules 340 for the respective item groups 320. By generating a feature space mapping for each of the feature tables 330, expression program 112 determines common or frequently used features in numeric expressions for the respective item groups 320. In this example, rules 340a correspond to expressions found in item group 320a and are based on the populated feature table 330a. Additionally, rules 340n correspond to expressions found in item group 320n and are based on the populated feature table 330n.

In this example, expression program 112 determines that three clusters of features are common when the numeric value of the item changes. The first cluster is associated with the normalized numeric range of a value greater than 793 g. The members of the cluster correspond with 28 oz., 2¼ lbs. and 5¾ ounces expressions of item group 320. Of the cluster, 28 oz. is an outlier and not included as a common feature for the range, as the common unit is pounds. The cluster also indicates that a fractional expression with a quarter fraction precision is common for the range. As such, expression program 112 generates a rule for the range of for values greater than 793 g, represent the numeric value in a fraction expression with quarter precision and in the “lbs.” unit.

Referring to the second rule corresponding to values between 28 g and 793 g, expression program 112 generates a rule for representation of a numeric value in the range in decimal format with ones precision and “oz.” as the unit. One of ordinary skill in the art will note that all expressions in this range from the item group 320a are measured in ounces (i.e., 4 oz., 9 oz., 16.2 ounces and 28 oz.), however “oz.” is selected since “oz.” is the frequent unit representation used in the cluster. As such, expression program 112 generates representation rules 116 that are not only common in mathematical representation but also in nomenclature representation. By ingesting documents from a domain, expression program 112 determines the common representations from the domain. Therefore, not only does expression program 112 determine common units, but also the common written representation of the unit within the domain (e.g., “oz.”, “ounces”, “Oz.”).

In some embodiments, expression program 112 receives a numeric value for formatting based on representation rules 116. For example, a user or other program requests the formatting of a numeric value. Additionally, expression program 112 receives an item, domain or other indicative information for formatting the numeric value. Expression program 112 compares the received item or domain to determine the corresponding representation rules 116 relating to said item or domain. Expression program 112 analyzes the corresponding representation rules 116 for the item based on the numeric value. Based on the corresponding representation rules 116, expression program 112 generates a formatted portion of text to provide to the requesting program or user. For example, a program requests for a formatting of the value “15.916348” grams for sugar in a baking recipe. Expression program 112 retrieves representation rules 116 corresponding to the item sugar in a baking domain. Expression program 112 analyzes the “15.916348” grams as a normalized value with respects to the corresponding representation rules 116. Expression program 112 generates a formatted text that incorporates the expression type, precision, and unit based on the range that “5.916348” grams falls into the corresponding representation rules 116. In this example, expression program 112 provides a formatted text string of “1 Tablespoon”.

FIG. 4 depicts a block diagram, 400, of components of computing device 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Expression program 112, text corpora 114 and representation rules 116 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. Expression program 112, text corpora 114 and representation rules 116 may be downloaded to persistent storage 408 through communications unit 410.

I/O interface(s) 412 allows for input and output of data with other devices that may be connected to computing device 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., expression program 112, text corpora 114 and representation rules 116, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that some term(s) may be subject to trademark rights in various jurisdictions throughout the world and are used here only in reference to the products or services properly denominated by the marks to the extent that such trademark rights may exist.

What is claimed is:

1-7. (canceled)

8. A computer program product comprising:
one or more computer-readable storage media and program instructions stored on the one or more computer-readable storage media, the program instructions comprising:
program instructions to identify a plurality of numeric expressions in a text corpus associated with a type of item;
program instructions to generate a plurality of feature vectors corresponding to the identified plurality of numeric expressions;
program instructions to identify one or more common features of the plurality of feature vectors; and
program instructions to generate one or more rules for representing numeric quantities of the type of item based, at least in part, on the one or more common features of the plurality of feature vectors.

9. The computer program product of claim 8, wherein the identified one or more common features are based, at least in part, on cluster analysis of the plurality of feature vectors mapped to a feature space.

10. The computer program product of claim 8, wherein the plurality of feature vectors include one or more of the following feature dimensions: (i) numeric value, (ii) expression type, (iii) expression precision, and (iv) unit of measurement.

11. The computer program product of claim 10, the program instructions further comprising:
program instructions to determine a respective plurality of normalized numeric values for the numeric value feature of the plurality of feature vectors.

12. The computer program product of claim 11, the program instructions further comprising:
program instructions to identify a first common feature of the plurality of feature vectors based, at least in part, on a first range of normalized numeric values; and
program instructions to identify a second common feature of the plurality of feature vectors based, at least in part, on a second range of normalized numeric values.

13. The computer program product of claim 12, wherein the one or more rules for representing numeric quantities include (i) the first common feature for numeric quantities in the first range of normalized numeric values and (ii) the second common feature for numeric quantities in the second range of normalized values.

14. The computer program product of claim 8, the program instructions further comprising:
program instructions to receive a numeric value associated with the type of item;
program instructions to retrieve one or more rules for representing numeric quantities of the type of item; and
program instructions to generate a formatted numeric expression based, at least in part, on the one or more rules for representing numeric quantities of the type of item, wherein the formatted numeric expression includes one or more of the following formatted features: (i) expression type, (iii) expression precision, and (iv) unit of measurement.

15. A computer system comprising:
one or more computer processors;
one or more computer readable storage media; and
program instructions stored on the computer readable storage media for execution by at least one of the one or more processors, the program instructions comprising:
program instructions to identify a plurality of numeric expressions in a text corpus associated with a type of item;
program instructions to generate a plurality of feature vectors corresponding to the identified plurality of numeric expressions;
program instructions to identify one or more common features of the plurality of feature vectors; and
program instructions to generate one or more rules for representing numeric quantities of the type of item based, at least in part, on the one or more common features of the plurality of feature vectors.

16. The computer system of claim 15, wherein the identified one or more common features are based, at least in part, on cluster analysis of the plurality of feature vectors mapped to a feature space.

17. The computer system of claim 15, wherein the plurality of feature vectors include one or more of the following feature dimensions: (i) numeric value, (ii) expression type, (iii) expression precision, and (iv) unit of measurement.

18. The computer system of claim 17, the program instructions further comprising:
program instructions to determine a respective plurality of normalized numeric values for the numeric value feature of the plurality of feature vectors.

19. The computer system of claim 18, the program instructions further comprising:
program instructions to identify a first common feature of the plurality of feature vectors based, at least in part, on a first range of normalized numeric values; and
program instructions to identify a second common feature of the plurality of feature vectors based, at least in part, on a second range of normalized numeric values.

20. The computer system of claim 19, wherein the one or more rules for representing numeric quantities include (i) the first common feature for numeric quantities in the first range of normalized numeric values and (ii) the second common feature for numeric quantities in the second range of normalized values.
